(19) United States
(12) Patent Application Publication
(10) Pub. No.: US 2021/0213760 A1
(43) Pub. Date: Jul. 15, 2021

(54) PRINTING APPARATUS

(71) Applicant: SEIKO EPSON CORPORATION, Tokyo (JP)

(72) Inventor: Tetsugo ISHIDA, Yamagata-mura (JP)

(21) Appl. No.: 17/144,249

(22) Filed: Jan. 8, 2021

(30) Foreign Application Priority Data
Jan. 10, 2020 (JP) 2020-002658

(51) Int. Cl. B41J 11/66; B41J 11/70

(52) U.S. Cl. CPC B41J 11/666; B41J 11/706

(57) ABSTRACT

A printing apparatus is able to perform partial cutting in which a portion of thermal paper remains uncut and full cutting in which the thermal paper is completely cut, and the printing apparatus includes a movable blade, a plate, and a driven gear. The plate includes a guide groove, the movable blade includes a guide shaft, the guide groove includes a first side and a second side, and the second side includes a certain portion extending in a direction away from the first side. When the driving gear rotates in a first rotational direction, the guide shaft changes a position with respect to the guide groove along the first side to perform the partial cutting, and when the driving gear rotates in a second rotational direction, the guide shaft changes the position with respect to the guide groove along the second side to perform the full cutting.

The present application is based on, and claims priority from JP Application Serial Number 2020-002658, filed Jan. 10, 2020, the disclosure of which is hereby incorporated by reference herein in its entirety.

### BACKGROUND

### 1. Technical Field

The present disclosure relates to a printing apparatus.

### 2. Related Art

Printers that include a movable blade for cutting recording paper after printing and that change the stroke of the movable blade to perform partial cutting in which a portion of the recording paper remains uncut and full cutting in which the recording paper is completely cut are known (for example, refer to JP-A-2006-181673).

In printers of the related art, the movable blade is provided with a sliding member to change the stroke of the movable blade. Therefore, the sliding member may result in increased cost, and abrasion of the sliding member may increase the risk of failure.

### SUMMARY

A printing apparatus according to an aspect is a printing apparatus configured to perform partial cutting in which a portion of recording paper remains uncut and full cutting in which the recording paper is completely cut, and the printing apparatus includes: a first blade; a plate configured to support the first blade; and a first rotating body that drives the first blade, in which one of the first blade and the plate includes a guide groove, the other of the first blade and the plate includes a guide shaft configured to be coupled to the guide groove, the guide groove has a first side and a second side, the second side includes a certain portion that extends in a direction away from the first side, when the first rotating body rotates in a first rotational direction to move the first blade toward the recording paper, the guide shaft changes a position with respect to the guide groove along the first side and the first blade performs the partial cutting, and when the first rotating body rotates in a second rotational direction different from the first rotational direction to move the first blade toward the recording paper, the guide shaft changes the position with respect to the guide groove along the second side and the first blade performs the full cutting.

### BRIEF DESCRIPTION OF THE DRAWINGS

FIG. 1 is a sectional side view illustrating an overall configuration of a printing apparatus.

FIG. 2 is a plan view of main parts of a driving mechanism.

FIG. 3A is a plan view of main parts of a movable blade according to a first embodiment.

FIG. 3B is a side view of the main parts of the movable blade according to the first embodiment.

FIG. 4A illustrates transition of the movable blade according to the first embodiment.

FIG. 4B illustrates transition of the movable blade according to the first embodiment.

FIG. 4C illustrates transition of the movable blade according to the first embodiment.

FIG. 5A illustrates transition of the movable blade according to the first embodiment.

FIG. 5B illustrates transition of the movable blade according to the first embodiment.

FIG. 5C illustrates transition of the movable blade according to the first embodiment.

FIG. 6 is a plan view of main parts of a movable blade according to a second embodiment.

FIG. 7A illustrates transition of the movable blade according to the second embodiment.

FIG. 7B illustrates transition of the movable blade according to the second embodiment.

### DESCRIPTION OF EXEMPLARY EMBODIMENTS

### 1. First embodiment

### 1-1. Configuration of Printing Apparatus

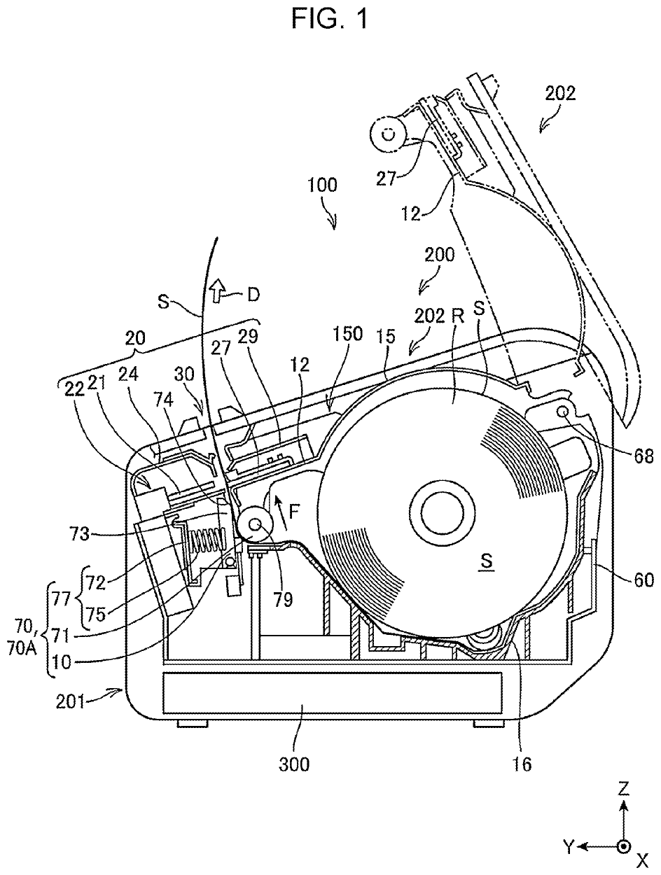

FIG. 1 is a sectional side view illustrating an overall configuration of a printing apparatus 100.

The printing apparatus 100 is applicable to, for example, a POS system. The POS system is a system usable in business such as the retail business of shopping malls, convenience stores, in-vehicle sales, and the like and the food service business of restaurants, cafes, pubs, and the like. The printing apparatus 100 prints and issues strip-like slips, receipts, coupons, tickets, or the like as individual sheets. The printing apparatus 100 is able to use long paper or sheets as recording paper for printing. The present embodiment describes an example in which the printing apparatus 100 is a thermal printer that performs printing on rolled thermal paper S as the recording paper. Note that the printing apparatus 100 is not limited to a thermal printer and may be a printing apparatus such as an ink jet printer that adopts a different printing system. Moreover, the recording paper may be referred to as a recording medium, a printing medium, or the like.

The printing apparatus 100 stores a paper roll R of the thermal paper S wound into a roll, draws out the thermal paper S from the paper roll R to transport the thermal paper S, prints certain information on the thermal paper S, and cuts the thermal paper S to a certain length. Note that the paper roll R may be a label paper roll, a unlined label paper roll, or the like.

In FIG. 1, the paper width direction of the thermal paper S is denoted by reference symbol X, the direction orthogonal to the X direction is denoted by reference symbol Y, and the direction orthogonal to the X direction and the Y direction is denoted by reference symbol Z. Moreover, the transport direction of the thermal paper S is denoted by reference symbol F.

As illustrated in FIG. 1, the printing apparatus 100 includes a printer mechanism 150, an outer case 200, and a control section 300. Note that the control section 300 may be referred to as a processor.

The outer case 200 includes a main body case 201 that covers a main body frame 60 and a cover case 202 that covers a cover frame 12.

The printer mechanism 150 includes the main body frame 60, the cover frame 12, a paper roll holder 16, a cutter mechanism 20, a paper discharge port 30, and a printing section 70. Note that the printing section 70 may function as a transport section 70A that transports the thermal paper S.

The main body frame 60 is substantially box shaped and has an opening upward in the Z direction. The cover frame 12 is attached to the main body frame 60 so as to be openable and closable about a support shaft 68. That is, the cover case 202 that covers the cover frame 12 is attached to the main body case 201, which covers the main body frame 60, so as to be openable and closable about the support shaft 68. The cover frame 12 may include a recess 15. The cover frame 12 includes the recess 15 to avoid contact with the paper roll R when the cover frame 12 is closed.

The paper roll holder 16 is a space covered by the cover frame 12 and is able to store the paper roll R. The paper discharge port 30 is an opening through which the thermal paper S is discharged. The paper discharge port 30 is an opening that is formed in the main body case 201 when the cover case 202 is closed. In the main body case 201 and the cover case 202 that form the paper discharge port 30, a portion of the paper discharge port 30 is provided in an end of the main body case 201 and a portion of the paper discharge port 30 is provided in an end of the cover case 202. Note that the paper discharge port 30 may be an opening formed in either the main body case 201 or the cover case 202. Further, the paper discharge port 30 may include, as a paper discharging function, a manual cutter for manually cutting the thermal paper S.

The printing section 70 is provided on a transport path D of the thermal paper S, which extends from the paper roll holder 16 to the paper discharge port 30. The printing section 70 includes a thermal head 10, a head holding mechanism 77, and a platen 71. The printing section 70 is able to be separated such that, when the cover frame 12 is opened, the thermal head 10 and the head holding mechanism 77 is on the main body frame 60 side and the platen 71 is on the cover frame 12 side. Note that the printing section 70 may be a constituent portion that forms the transport path D.

The thermal head 10 includes a plurality of heating elements (not illustrated) provided in the paper width direction, denoted by reference symbol X, and a heat dissipation plate 73. An inclined guide section 74 is provided at an upper part of the heat dissipation plate 73 in the Z direction. When the cover frame 12 is closed, the inclined guide section 74 guides the platen 71 described later to a certain position. In other words, the platen 71 slides on the inclined guide section 74 and reaches the certain position. Note that the inclined guide section 74 may be integrated with or separate from the heat dissipation plate 73.

The head holding mechanism 77 includes a head press plate 72 and an urging member 75 attached to the head press plate 72 and is attached to the main body frame 60. The urging member 75 is coupled to the head press plate 72 and the heat dissipation plate 73 of the thermal head 10 and urges the thermal head 10 toward the platen 71. Note that a spring member such as a compression coil spring is an example of the urging member 75.

The platen 71 is a roller formed from an elastic member such as rubber. The platen 71 is rotatably supported by the cover frame 12 via a platen bearing 79. When the cover frame 12 is closed, the platen 71 slides on the inclined guide section 74 of the thermal head 10 and abuts the heating elements of the thermal head 10 in an opposed manner. In other words, the platen 71 and the thermal head 10 are brought into pressure contact with each other.

The platen 71 abuts the thermal head 10 with the thermal paper S pinched therebetween. That is, the thermal head 10 and the platen 71 are pressed against the thermal paper S. When the platen 71 rotates in response to power of a paper feed motor (not illustrated), the thermal paper S is transported to the paper discharge port 30. The printing apparatus 100 selectively energizes the heating elements of the thermal head 10 while transporting the thermal paper S and prints certain information on the thermal paper S by using the heating elements that generate heat upon energization.

The thermal paper S on which printing has been preformed by the printing section 70 is cut by the cutter mechanism 20 to a certain length and issued as an individual sheet such as a receipt. Note that the printed thermal paper S may be cut leaving a certain margin near a printed image.

The control section 300 is provided in a lower portion of the printer mechanism 150 in the Z direction. The printer mechanism 150 is stored in the outer case 200 together with the control section 300. The control section 300 controls operation of the printing apparatus 100.

The control section 300 receives commands from a host computer (not illustrated) connected to the printing apparatus 100 and controls the respective sections of the printing apparatus 100. For example, when receiving, from the host computer, a print command providing a printing instruction or a cut command providing a cutting instruction, the control section 300 controls operation of the printing section 70 to transport the thermal paper S and perform printing thereon and then causes the cutter mechanism 20 to cut the thermal paper S. Note that the control section 300 may include a communication section such as a communication interface and may be configured to receive a command through the communication section.

### 1-2. Configuration of Cutter Mechanism

The cutter mechanism 20 is provided upstream of the paper discharge port 30 in the transport direction of the thermal paper S and causes a movable blade 21 and a fixed blade 27 to cut the thermal paper S on which printing has been performed by the thermal head 10. The movable blade 21 is attached on the main body frame 60 side and the fixed blade 27 is attached on the cover frame 12 side. Note that the movable blade 21 and the fixed blade 27 are examples of a first blade and a second blade, respectively. The movable blade 21 may be attached on the cover frame 12 side and the fixed blade 27 may be attached on the main body frame 60 side. The present embodiment describes an example in which the movable blade 21 is attached on the main body frame 60 side and the fixed blade 27 is attached on the cover frame 12 side.

The movable blade 21 and a driving mechanism 22 that drives the movable blade 21 are stored in a first cutter cover 24 provided on the main body frame 60 side. On the other hand, the fixed blade 27 is stored in a second cutter cover 29 provided on the cover frame 12 side. The fixed blade 27 is provided at a position facing the movable blade 21 with the transport path D therebetween. Note that the first cutter cover 24 and the second cutter cover 29 are not necessarily required. The present embodiment describes an example in which the first cutter cover 24 is provided on the main body frame 60 side and the second cutter cover 29 is provided on the cover frame 12 side.

When the cover frame 12 is opened to set the paper roll R in the paper roll holder 16, the fixed blade 27 moves together with the cover frame 12 and is away from the movable blade 21. In this state, the paper roll R is set in the paper roll holder 16. Then, the thermal paper S that is drawn out from the paper roll R is caused to pass between the movable blade 21 and the fixed blade 27 and the cover frame 12 is closed. Thereby, the thermal paper S is disposed between the movable blade 21 and the fixed blade 27.

The movable blade 21 is driven by the driving mechanism 22 to be reciprocated between a standby position and a cutting position. The movable blade 21 moves from the standby position to the cutting position to cut the thermal paper S. After cutting the thermal paper S, the movable blade 21 moves from the cutting position to the standby position to expose the transport path D and enables the thermal paper S to be transported.

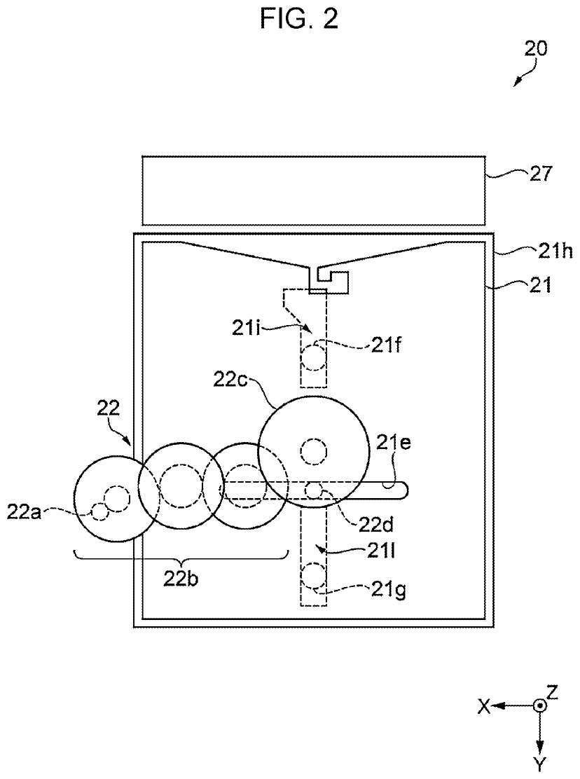

FIG. 2 is a plan view of main parts of the driving mechanism 22. Note that, in the following drawings, reference symbol X denotes the right-left direction, reference symbol Y denotes the front-rear direction, and reference symbol Z denotes the up-down direction. Here, the direction indicated by the arrow denoted by reference symbol X is the leftward direction, the direction indicated by the arrow denoted by reference symbol Y is the frontward direction, and the direction indicated by the arrow denoted by reference symbol Z is the upward direction. Further, the right-left direction in the following drawings indicates the width direction of each of the printing apparatus 100, the movable blade 21, and the fixed blade 27.

The driving mechanism 22 includes a motor (not illustrated), a gear 22a that is a rotational shaft of the motor, a gear train 22b that is coupled to the gear 22a to transfer rotation of the gear 22a, and a driven gear 22c that is coupled to the gear train 22b to rotate. The motor is, for example, a stepping motor or a DC motor and drives the gear 22a in accordance with control of the control section 300. The gear 22a is driven by the motor to rotate in a right-handed or left-handed direction. In other words, the gear 22a rotates clockwise or counterclockwise. The motor is installed to stand vertically in the Z direction in the main body case 201, and the gear 22a and the gear train 22b are coupled. Note that the motor is not limited to being installed to stand vertically and may be installed in another state. Moreover, the gear 22a includes, for example, a worm gear.

The gear train 22b includes a plurality of gears that transfer rotation of the gear 22a to the driven gear 22c. The gear train 22b may be, for example, a speed-reducing gear train that reduces the rotational speed of the gear 22a and transfers the rotation to the driven gear 22c. Further, the gear train 22b is not limited to including the plurality of gears and may include one gear. The gear train 22b is not necessarily required, and the structure may be such that the gear 22a is directly coupled to the driven gear 22c. The present embodiment describes, for example, a structure in which the driven gear 22c is coupled to the gear 22a via the gear train 22b.

The driven gear 22c is a gear that is rotated by the gear 22a and the gear train 22b and has a crank pin 22d disposed on the surface facing the movable blade 21. The crank pin 22d is coupled to a slide groove 21e of the movable blade 21, which will be described below, to drive the movable blade 21. When the driven gear 22c rotates, the crank pin 22d moves along the slide groove 21e. Then, the movable blade 21 pushed by the crank pin 22d is reciprocated between the standby position and the cutting position. Note that the driven gear 22c is an example of a first rotating body. The first rotating body is not limited to a gear and may be a cam or the like. As an example of the first rotating body in the present embodiment, the driven gear 22c will be described.

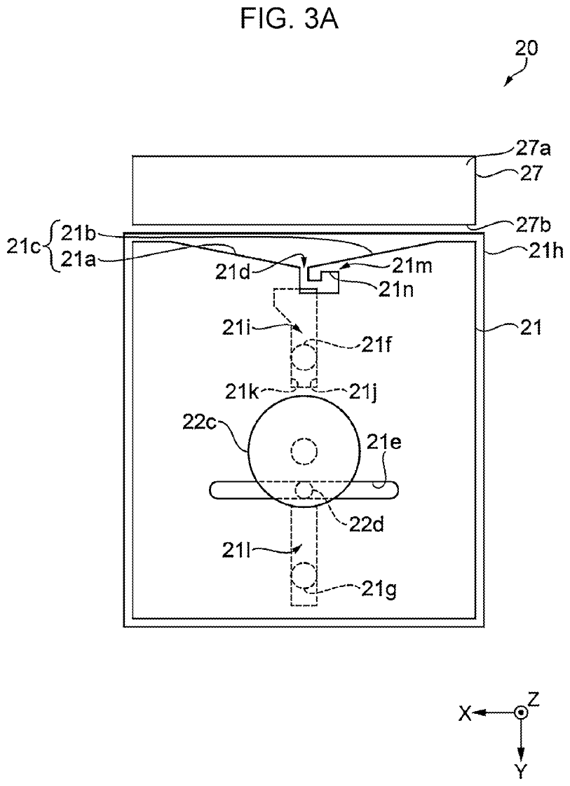

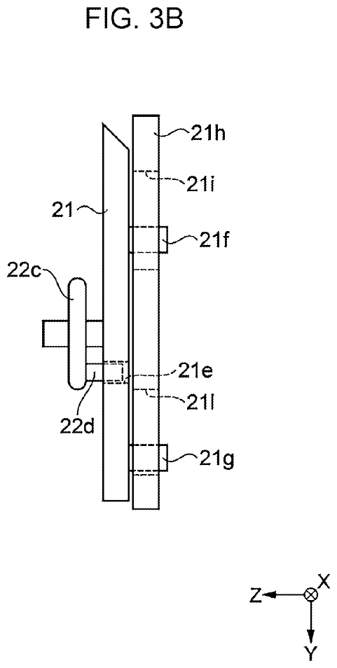

FIG. 3A is a plan view of main parts of the movable blade 21 and the fixed blade 27.

The movable blade 21 is formed from, for example, a plate member made of metal and has a V-shaped cutting edge 21c that faces the fixed blade 27. The V-shaped cutting edge 21c is the rearward end of the movable blade 21 in the Y direction of the printing apparatus 100. The V-shaped cutting edge 21c is an example of a blade section. The V-shaped cutting edge 21c is a cutter blade having a V-shape obtained by combining a left cutting edge 21a and a right cutting edge 21b with both ends of the movable blade 21 in the width direction closest to the fixed blade 27 and the center portion in the width direction furthest from the fixed blade 27. The cutting edge 21a and the cutting edge 21b are disposed with a gap therebetween in the center of the movable blade 21 in the width direction. The gap serves as a notch section 21d. In the movable blade 21, the V-shaped cutting edge 21c is a region in which the thermal paper S is cut and the notch section 21d is a region in which an uncut portion of the thermal paper S is formed. Note that the V-shaped cutting edge 21c is not required to have a V-shape in a strict sense and is required only to have a configuration in which the left cutting edge 21a and the right cutting edge 21b are coupled at a certain angle via the notch section 21d. Moreover, the notch section 21d is not limited to being provided in the center of the movable blade 21 in the width direction and may be provided at a position shifted from the center. The left cutting edge 21a and the right cutting edge 21b are not limited to being linear in shape and may have a partially curved shape or the like. The V-shaped cutting edge 21c is an example of a first cutting edge.

The movable blade 21 may have an angled structure 21m. The angled structure 21m is a structure that has a claw shape and that is provided in the left-side end of the right cutting edge 21b in the X direction. However, the angled structure 21m may be provided in the right-side end of the left cutting edge 21a in the X direction. The angled structure 21m is formed in the movable blade 21 by a portion of the notch section 21d that extends frontward in the Y direction, a portion thereof that extends in the X direction, and a portion thereof that extends rearward in the Y direction. In other words, the angled structure 21m is formed in the movable blade 21 by the notch section 21d that is bent at a certain position. Alternatively, as is the case with the right cutting edge 21b, the angled structure 21m is formed in the movable blade 21 so as to include a protruding portion that protrudes frontward in the Y direction from the left-side end of the right cutting edge 21b in the X direction.

A tip portion of the angled structure 21m is formed by a recess which includes the portion of the notch section 21d that extends rearward in the Y direction. In the tip portion, an end extending in the X direction, which corresponds to an end opposite to an end provided frontward in the Y direction, is defined as a cutting end 21n. Note that the angled structure 21m is not limited to being provided in the end of the left cutting edge 21a or the end of the right cutting edge 21b and may be provided at a position shifted from the center. The angled structure 21m may have a structure formed only by a portion of the notch section 21d that extends frontward in the Y direction and a portion thereof that extends in the X direction. In this case, the recess of the angled structure 21m is a recess that includes the portion extending in the X direction. Regarding the ends of the recess of the angled structure 21m that extend in the X direction, an end opposite to an end provided frontward in the Y direction is defined as the cutting end 21n. The cutting end 21n may have a cutting edge similar to the left cutting edge 21a or the right cutting edge 21b of the movable blade 21. The movable blade 21 is not required to have the angled structure 21m. For example, the movable blade 21 may have the notch section 21d formed only by a portion extending frontward in the Y direction. As an example in the present embodiment, the movable blade 21 having the angled structure 21m will be described.

The movable blade 21 includes the slide groove 21e that is a linear groove extending in the X direction and having both ends of an arc shape. The slide groove 21e is coupled to the crank pin 22d of the driven gear 22c. Thus, the slide groove 21e width in the Y direction is larger than the crank pin 22d width in the Y direction. The slide groove 21e may be in direct contact with the crank pin 22d or may be in indirect contact with the crank pin 22d via another member. For example, the structure may be such that a guiding member of the crank pin 22d is attached to the slide groove 21e, the guiding member and the crank pin 22d are brought into direct contact with each other, and the slide groove 21e and the crank pin 22d are brought into indirect contact with each other via the guiding member. The slide groove 21e width in the X direction is desirably larger than the diameter of the driven gear 22c. Moreover, the center of the slide groove 21e in the X direction is desirably on the line that passes through the center of the movable blade 21 in the X direction and that extends in the Y direction. In other words, the center of the slide groove 21e is desirably on the center line of the movable blade 21. The shape of the slide groove 21e is not limited to the shape having both ends in the arc shape and may be, for example, a rectangular shape.

The movable blade 21 includes guide shafts 21f and 21g. The guide shafts 21f and 21g are desirably positioned on the center line in the X direction of the movable blade 21. The guide shafts 21f and 21g, which correspond to metal pins of a cylindrical shape, protrude downward in the Z direction and are coupled respectively to guide grooves 21i and 21l of a plate 21h described later. When the movable blade 21 is reciprocated between the standby position and the cutting position, the guide shafts 21f and 21g respectively change the positions with respect to the guide grooves 21i and 21l. More specifically, the guide shafts 21f and 21g move respectively along the guide grooves 21i and 21l. Note that the shape of the guide shafts 21f and 21g is not limited to a cylindrical shape and may be a shape such as a square column or hexagonal column. One of the guide shafts 21f and 21g may be larger than the other. Moreover, the number of guide shafts of the present embodiment is two but may be one. The guide shafts 21f and 21g are not required to be made of metal and may be made of a resin such as plastic. The guide shafts 21f and 21g may be referred to respectively as a first guide shaft and a second guide shaft.

The movable blade 21 is placed on the plate 21h provided below the movable blade 21 in the Z direction and is able to slide on the plate 21h. The plate 21h is formed from, for example, a metal plate member and supports the movable blade 21. The plate 21h has the guide grooves 21i and 21l. The guide grooves 21i and 21l are grooves extending in the Y direction and are coupled respectively to the guide shafts 21f and 21g of the movable blade 21. Thus, the widths of the guide grooves 21i and 21l in the X direction are respectively larger than the widths of the guide shafts 21f and 21g in the X direction. The guide groove 21i has a first side 21j disposed on the right side of the guide shaft 21f of the movable blade 21 in the X direction and a second side 21k disposed on the left side thereof in the X direction. The first side 21j and the second side 21k are sides used for the guide shaft 21f to be guided and are side portions of the guide groove 21i. The first side 21j extends in the Y direction. In the second side 21k, a portion facing the first side 21j and extending in the Y direction is provided frontward in the Y direction and a portion extending in the direction away from the first side 21j is provided rearward in the Y direction. The portion facing the first side 21j and extending in the Y direction may be referred to as a first portion and the portion extending in the direction away from the first side 21j may be referred to as a second portion. The direction away from the first side 21j is a direction in which a distance in the X direction between the first side 21j and the second side 21k increases with respect to the Y direction and is a direction in which the guide groove 21i width in the X direction increases. In other words, the direction is a direction in which the guide groove 21i widens in the width direction of the movable blade 21. The dimension of the first portion in the Y direction may be longer or shorter than the dimension of the second portion in the Y direction. Alternatively, the dimension of the first portion in the Y direction may be the same as the dimension of the second portion in the Y direction. In addition, the second side 21k may have no first portion.

One of the guide grooves 21i and 21l may be larger than the other in accordance with the guide shaft 21f or 21g. Further, the number of guide grooves of the present embodiment is two but may be one. The guide grooves 21i and 21l may be referred to respectively as a first guide groove and a second guide groove.

The fixed blade 27 is formed from, for example, an elongated plate member made of metal and includes a cutting edge 27b facing the movable blade 21. The cutting edge 27b has a linear shape. The movable blade 21 moves to the cutting position by riding over an upper surface 27a of the fixed blade 27 and cuts the thermal paper S by pinching the thermal paper S between the V-shaped cutting edge 21c and the cutting edge 27b. Here, the notch section 21d has no V-shaped cutting edge 21c and thus does not cut the thermal paper S. Accordingly, the notch section 21d forms an uncut portion of the thermal paper S. Note that the fixed blade 27 is not limited to being linear in shape and may have a partially curved shape or the like. The movable blade 21 may move diagonally upward in the Z direction by riding over the fixed blade 27. Alternatively, while the fixed blade 27 is pushed by the movable blade 21 and sinks downward in the Z direction, the movable blade 21 itself may move in a straight line.

FIG. 3B is a side view of main parts of the movable blade 21.

The driven gear 22c is provided above the movable blade 21 in the Z direction, and the plate 21h is provided below the movable blade 21 in the Z direction. When the driven gear 22c rotates, the crank pin 22d moves along the slide groove 21e. In accordance with the movement of the crank pin 22d, the guide shafts 21g and 21f of the movable blade 21 are guided by the guide grooves 21i and 21l to move. A shaft portion of the driven gear 22c, which is in contact with the movable blade 21, may be provided with an urging member that urges the movable blade 21 downward in the Z direction. The urging member enables the movable blade 21 to move with a stable orientation. Note that a positional relationship between the movable blade 21, the driven gear 22c, and the plate 21h in the Z direction is not limited to the aforementioned relationship. For example, the driven gear 22c may be provided below the movable blade 21 and the plate 21h in the Z direction.

### 1-3. Operation of Cutter Mechanism

The printing apparatus 100 acquires a print command or a cut command from the host computer (not illustrated), transports the thermal paper S by using the platen 71, causes the printing section 70 to perform printing, and causes the cutter mechanism 20 to cut the thermal paper S. In the present embodiment, the cutter mechanism 20 is able to cut the thermal paper S by performing partial cutting in which a portion of the thermal paper S remains uncut or full cutting in which the thermal paper S is completely cut. The cutter mechanism 20 is able to switch between the partial cutting and the full cutting in accordance with a rotational direction of the driven gear 22c. For example, when the driven gear 22c rotates in the right-handed direction, the movable blade 21 of the cutter mechanism 20 performs the partial cutting of the thermal paper S, and when the driven gear 22c rotates in the left-handed direction, the movable blade 21 performs the full cutting of the thermal paper S. The operation of the cutter mechanism 20 performing the partial cutting or the full cutting will be described below. Note that the rotation of the driven gear 22c in the right-handed direction and the rotation thereof in the left-handed direction are examples of a first rotational direction and a second rotational direction, respectively.

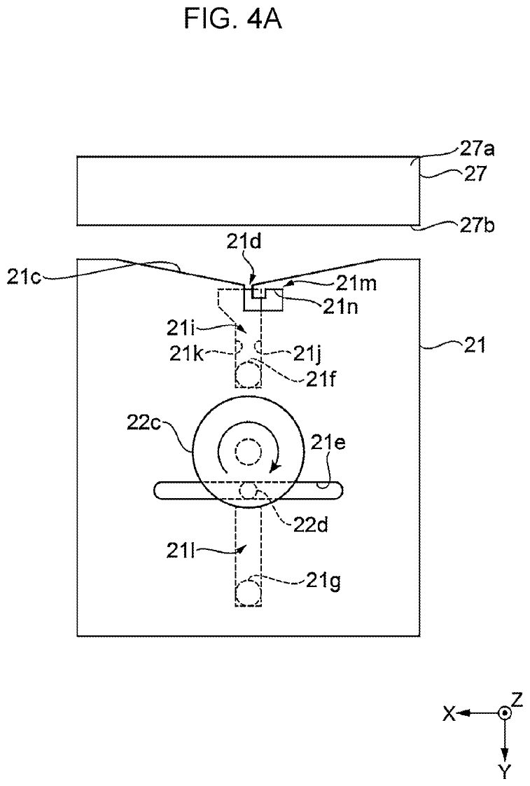

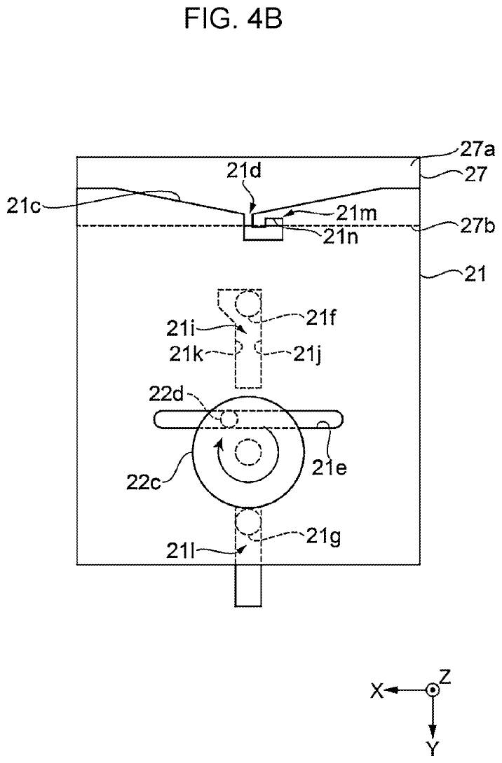

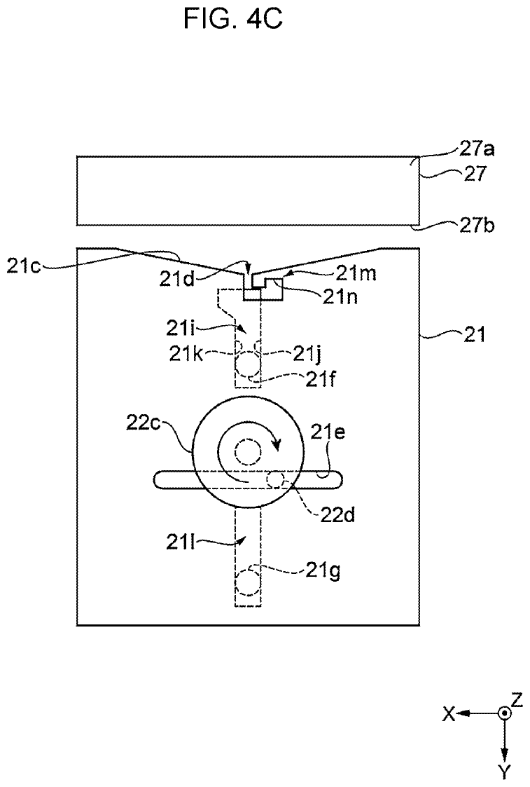

FIGS. 4A to 4C illustrate transition of the movable blade 21. In FIGS. 4A to 4C, an example in which the driven gear 22c rotates in the first rotational direction will be described. FIG. 4A is a plan view of the main parts when the movable blade 21 is at the standby position, FIG. 4B is a plan view of the main parts when the movable blade 21 is at the cutting position, and FIG. 4C is a plan view of the main parts when the movable blade 21 moves from the cutting position to the standby position. Note that, in FIGS. 4A to 4C, regarding the plate 21h, the guide grooves 21i and 21l are illustrated and illustration of exterior shape is omitted.

In FIG. 4A, the movable blade 21 is at the standby position. The crank pin 22d and the guide shafts 21f and 21g are arranged side by side along the line in the Y direction and are each positioned frontward in the Y direction. The guide shafts 21f and 21g are respectively on the front sides of the guide grooves 21i and 21l in the Y direction. When the driven gear 22c rotates in the first rotational direction, the crank pin 22d moves, in the first rotational direction, rearward in the Y direction. During the movement, the crank pin 22d moves, along the slide groove 21e, leftward in the X direction and then rightward in the X direction. In other words, the crank pin 22d moves leftward in the X direction so as to follow a mountain-like curve. The movable blade 21 is pushed by the crank pin 22d moving along the slide groove 21e and moves rearward in the Y direction so as to reach the cutting position. Then, the guide shafts 21f and 21g move, respectively along the guide grooves 21i and 21l, rearward in the Y direction in accordance with the movement of the movable blade 21.

In FIG. 4B, the movable blade 21 cuts the thermal paper S. The crank pin 22d moves, in the first rotational direction, rearward in the Y direction and the movable blade 21 reaches the cutting position. Until reaching the cutting position, the movable blade 21 receives a force from the crank pin 22d urging movement in the X direction. In particular, while the crank pin 22d moves, along the slide groove 21e, rightward in the X direction, the movable blade 21 receives, via the slide groove 21e, the force from the crank pin 22d urging rightward movement in the X direction. In other words, at least when the crank pin 22d is moving, along the slide groove 21e, rightward in the X direction, the movable blade 21 moves toward the cutting position while being pushed by the crank pin 22d rightward in the X direction.

Since the movable blade 21 is pushed by the crank pin 22d rightward in the X direction, the guide shaft 21f of the movable blade 21 is in contact with the first side 21j of the guide groove 21i on the right side in the X direction. Then, the guide shaft 21f moves, along the first side 21j, rearward in the Y direction of the guide groove 21i. Note that the guide shaft 21f may be in direct contact with the first side 21j or may be in indirect contact with the first side 21j via another member. In other words, the guide shaft 21f is required only to move along the first side 21j. Since the first side 21j is a side extending in the Y direction, the movable blade 21 is guided by the first side 21j to move rearward in the Y direction and cuts the thermal paper S. More specifically, the V-shaped cutting edge 21c of the movable blade 21 cuts the thermal paper S and the notch section 21d of the movable blade 21 forms an uncut portion of the thermal paper S. The direction in which the movable blade 21 cuts the thermal paper S, which corresponds to rearward in the Y direction, is defined as a cutting direction.

In FIG. 4C, the movable blade 21 returns to the standby position. The crank pin 22d moves, in the first rotational direction, from rearward to frontward in the Y direction. During the movement, the crank pin 22d moves, along the slide groove 21e, rightward in the X direction and then leftward in the X direction. In other words, the crank pin 22d moves rightward in the X direction so as to follow a mountain-like curve. The movable blade 21 is pushed by the crank pin 22d moving along the slide groove 21e and moves frontward in the Y direction so as to reach the standby position.

Until returning to the standby position, the movable blade 21 receives the force from the crank pin 22d urging movement in the X direction. In particular, while the crank pin 22d moves, along the slide groove 21e, rightward in the X direction, the movable blade 21 receives, via the slide groove 21e, the force from the crank pin 22d urging rightward movement in the X direction. In other words, at least when the crank pin 22d is moving, along the slide groove 21e, rightward in the X direction, the movable blade 21 moves toward the standby position while being pushed by the crank pin 22d rightward in the X direction. Since the movable blade 21 is pushed by the crank pin 22d rightward in the X direction, the guide shaft 21f of the movable blade 21 is in contact with the first side 21j of the guide groove 21i on the right side in the X direction. Then, the guide shaft 21f moves, along the first side 21j, frontward in the Y direction of the guide groove 21i. Since the first side 21j is a side extending in the Y direction, the movable blade 21 is guided by the first side 21j to move frontward in the Y direction and moves toward the standby position while being away from the thermal paper S that is cut. Since the movable blade 21 is guided by the first side 21j until the movable blade 21 cuts the thermal paper S and is away from the thermal paper S, the movable blade 21 moves in the cutting direction and in the direction opposite to the cutting direction. According to such a configuration, the movable blade 21 performs the partial cutting in which a portion of the thermal paper S remains uncut. In other words, when the driven gear 22c rotates in the first rotational direction, the movable blade 21 performs the partial cutting.

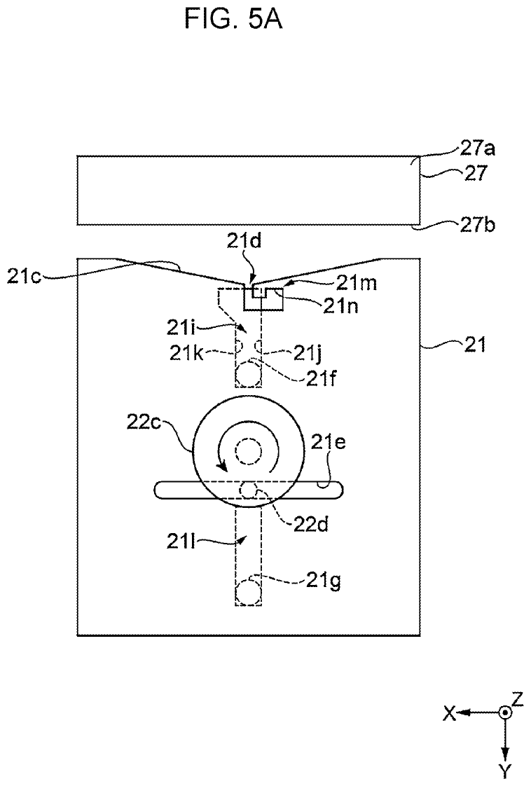

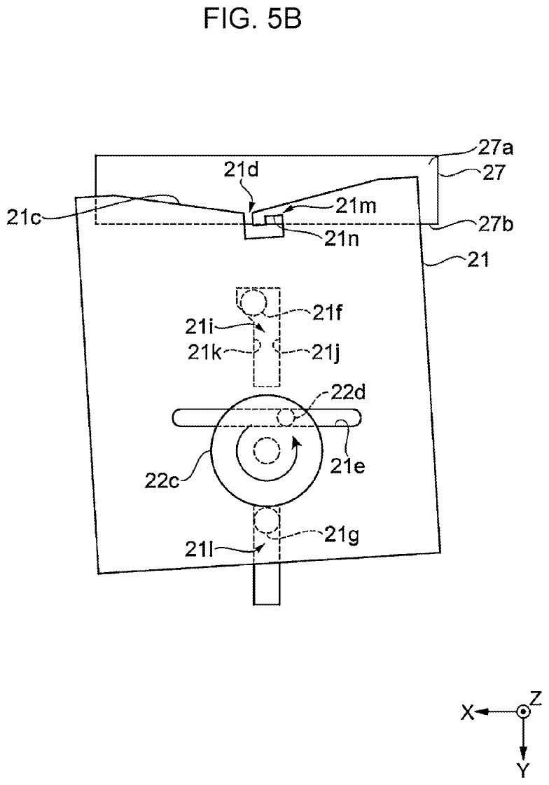

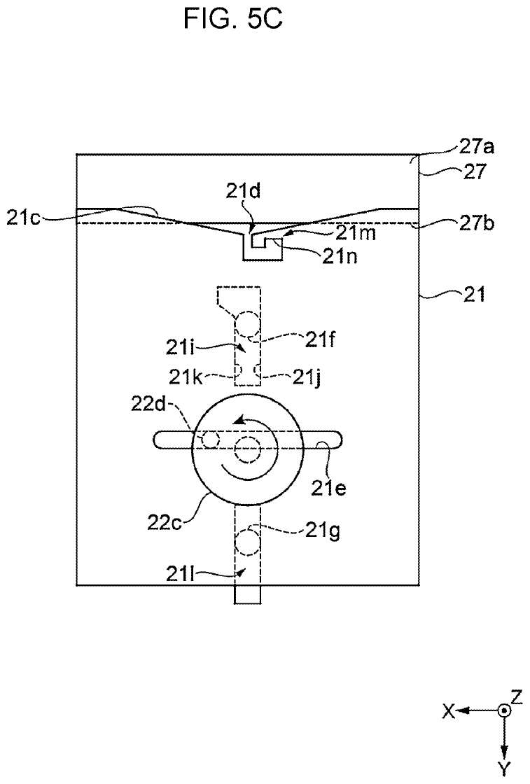

FIGS. 5A to 5C illustrate transition of the movable blade 21. In FIGS. 5A to 5C, an example in which the driven gear 22c rotates in the second rotational direction will be described. FIG. 5A is a plan view of the main parts when the movable blade 21 is at the standby position, FIG. 5B is a plan view of the main parts when the movable blade 21 is at the cutting position, and FIG. 5C is a plan view of the main parts when the movable blade 21 moves from the cutting position to the standby position. Note that, in FIGS. 5A to 5C, regarding the plate 21h, the guide grooves 21i and 21l are illustrated and illustration of exterior shape is omitted.

In FIG. 5A, the movable blade 21 is at the standby position. The crank pin 22d and the guide shafts 21f and 21g are arranged side by side along the line in the Y direction and are each positioned frontward in the Y direction. The guide shafts 21f and 21g are respectively on the front sides of the guide grooves 21i and 21l in the Y direction. When the driven gear 22c rotates in the second rotational direction, the crank pin 22d moves, in the second rotational direction, rearward in the Y direction. During the movement, the crank pin 22d moves, along the slide groove 21e, rightward in the X direction and then leftward in the X direction. In other words, the crank pin 22d moves rightward in the X direction so as to follow a mountain-like curve. The movable blade 21 is pushed by the crank pin 22d moving along the slide groove 21e and moves rearward in the Y direction so as to reach the cutting position. Then, the guide shafts 21f and 21g move, respectively along the guide grooves 21i and 21l, rearward in the Y direction in accordance with the movement of the movable blade 21.

In FIG. 5B, the movable blade 21 cuts the thermal paper S. The crank pin 22d moves, in the second rotational direction, rearward in the Y direction and the movable blade 21 reaches the cutting position. Until reaching the cutting position, the movable blade 21 receives the force from the crank pin 22d urging movement in the X direction. In particular, while the crank pin 22d moves, along the slide groove 21e, leftward in the X direction, the movable blade 21 receives, via the slide groove 21e, the force from the crank pin 22d urging leftward movement in the X direction. In other words, at least when the crank pin 22d is moving, along the slide groove 21e, leftward in the X direction, the movable blade 21 moves toward the cutting position while being pushed by the crank pin 22d leftward in the X direction.

Since the movable blade 21 is pushed by the crank pin 22d leftward in the X direction, the guide shaft 21f of the movable blade 21 is in contact with the second side 21k of the guide groove 21i on the left side in the X direction. Then, the guide shaft 21f moves, along the second side 21k, rearward in the Y direction of the guide groove 21i. Note that the guide shaft 21f may be in direct contact with the second side 21k or may be in indirect contact with the second side 21k via another member. In other words, the guide shaft 21f is required only to move along the second side 21k. Since the second side 21k includes the first portion and the second portion, the movable blade 21 is guided by the first portion of the second side 21k to move in the Y direction and is then guided by the second portion of the second side 21k to move in the direction away from the first side 21j, which corresponds to the direction inclined with respect to the cutting direction, and cuts the thermal paper S.

By the movable blade 21 moving in the cutting direction, the V-shaped cutting edge 21c cuts the thermal paper S and the notch section 21d forms an uncut portion of the thermal paper S. After that, by moving in the direction inclined with respect to the cutting direction, the movable blade 21 also cuts the uncut portion of the thermal paper S. Note that the thermal paper S may be cut only by the V-shaped cutting edge 21c of the movable blade 21 without an uncut portion of the thermal paper S being formed by the notch section 21d. The present embodiment describes an example in which an uncut portion is formed by the notch section 21d. Examples of the movable blade 21 moving in the direction inclined with respect to the cutting direction also include the movable blade 21 being inclined or rotating with respect to the cutting direction upon movement of the guide shaft 21f along the second portion of the second side 21k with the guide shaft 21g as a fulcrum.

By moving in the direction inclined with respect to the cutting direction, the movable blade 21 may cut an uncut portion of the thermal paper S by using the widthwise center of the V-shaped cutting edge 21c. Alternatively, by hooking an uncut portion of the thermal paper S on the cutting end 21n of the angled structure 21m when the movable blade 21 moves in the direction inclined with respect to the cutting direction, the uncut portion of the thermal paper S may be cut by being pulled and torn by the cutting end 21n when the movable blade 21 moves from the cutting position to the standby position. In this case, the cutting end 21n width in the X direction is desirably larger than the notch section 21d width in the X direction. Thereby, the cutting end 21n width in the X direction is larger than the width of the uncut portion of the thermal paper S in the X direction, resulting in the uncut portion of the thermal paper S being easily hooked on the cutting end 21n and the uncut portion of the thermal paper S being able to be more reliably cut.

In FIG. 5C, the movable blade 21 returns to the standby position. The crank pin 22d moves, in the second rotational direction, from rearward to frontward in the Y direction. During the movement, the crank pin 22d moves, along the slide groove 21e, leftward in the X direction and then rightward in the X direction. In other words, the crank pin 22d moves leftward in the X direction so as to follow a mountain-like curve. The movable blade 21 is pushed by the crank pin 22d moving along the slide groove 21e and moves frontward in the Y direction so as to reach the standby position.

Until returning to the standby position, the movable blade 21 receives the force from the crank pin 22d urging movement in the X direction. In particular, while the crank pin 22d moves, along the slide groove 21e, leftward in the X direction, the movable blade 21 receives, via the slide groove 21e, the force from the crank pin 22d urging leftward movement in the X direction. In other words, at least when the crank pin 22d is moving, along the slide groove 21e, leftward in the X direction, the movable blade 21 moves toward the standby position while being pushed by the crank pin 22d leftward in the X direction. Since the movable blade 21 is pushed by the crank pin 22d leftward in the X direction, the guide shaft 21f of the movable blade 21 is in contact with the second side 21k of the guide groove 21i on the left side in the X direction. The guide shaft 21f moves, along the second side 21k, frontward in the Y direction of the guide groove 21i. Since the movable blade 21 is guided by the second side 21k until the movable blade 21 cuts the thermal paper S and is away from the thermal paper S, the movable blade 21 moves at least in the direction inclined with respect to the cutting direction and in the direction opposite to the direction inclined with respect to the cutting direction. According to such a configuration, the movable blade 21 performs the full cutting in which the thermal paper S is completely cut. In other words, when the driven gear 22c rotates in the second rotational direction, the movable blade 21 performs the full cutting.

### 2. Second Embodiment

### 2-1. Configuration of Cutter Mechanism

Next, a cutter mechanism 120 of a second embodiment will be described. Note that description that overlaps the description of the cutter mechanism 20 of the first embodiment will be omitted. Further, components that overlap the components of the cutter mechanism 20 of the first embodiment will be described by using the same reference numerals.

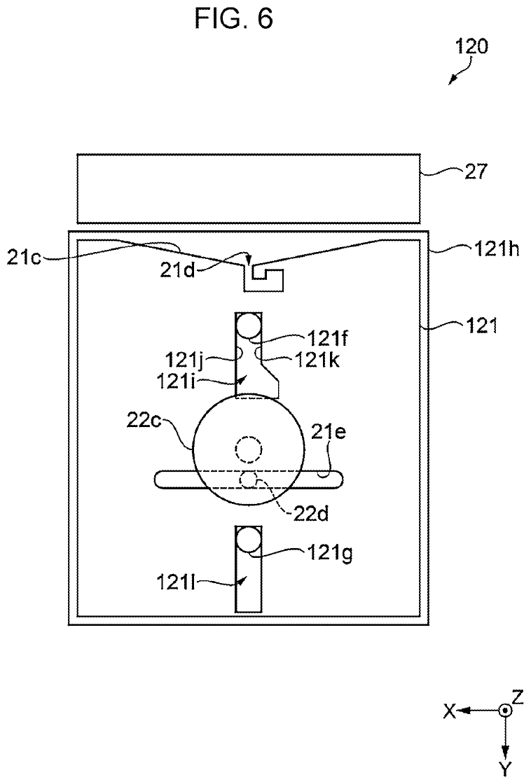

FIG. 6 is a plan view of main parts of a movable blade 121 and the fixed blade 27.

The cutter mechanism 120 includes the movable blade 121. The movable blade 121 is different from that of the first embodiment and includes guide grooves 121i and 121l. The guide grooves 121i and 121l are grooves extending in the Y direction and are respectively coupled to guide shafts 121f and 121g of a plate 121h described later. Thus, the widths of the guide grooves 121i and 121l in the X direction are respectively larger than the widths of the guide shafts 121f and 121g in the X direction. The guide groove 121i has a first side 121j disposed on the left side of the guide shaft 121f of the plate 121h in the X direction and a second side 121k disposed on the right side thereof in the X direction. The first side 121j and the second side 121k are sides used for the guide shaft 121f to be guided and are side portions of the guide groove 121i. The first side 121j extends in the Y direction. In the second side 121k, a portion facing the first side 121j and extending in the Y direction is provided rearward in the Y direction and a portion extending in the direction away from the first side 121j is provided frontward in the Y direction. The portion facing the first side 121j and extending in the Y direction may be referred to as a first portion and the portion extending in the direction away from the first side 121j may be referred to as a second portion. The dimension of the first portion in the Y direction may be longer or shorter than the dimension of the second portion in the Y direction. Alternatively, the dimension of the first portion in the Y direction may be the same as the dimension of the second portion in the Y direction. In addition, the second side 121k may have no first portion.

One of the guide grooves 121i and 121l may be formed to be larger than the other in accordance with the guide shaft 121f or 121g. The number of guide grooves of the present embodiment is two but may be one. The guide grooves 121i and 121l may be referred to respectively as a first guide groove and a second guide groove.

The movable blade 121 is placed on the plate 121h provided below the movable blade 121 in the Z direction and is able to slide on the plate 121h. The plate 121h is different from that of the first embodiment and includes the guide shafts 121f and 121g. The guide shafts 121f and 121g are desirably positioned on the center line in the X direction of the plate 121h. The guide shafts 121f and 121g, which correspond to metal pins of a cylindrical shape, protrude upward in the Z direction and are coupled respectively to the guide grooves 121i and 121l of the movable blade 121. When the movable blade 121 is reciprocated between the standby position and the cutting position, the guide shafts 121f and 121g respectively change the positions with respect to the guide grooves 121i and 121l. More specifically, the guide grooves 121i and 121l move while respectively being in contact with the guide shafts 121f and 121g. Note that the shape of the guide shafts 121f and 121g is not limited to the cylindrical shape and may be a shape such as a square column or hexagonal column. One of the guide shafts 121f and 121g may be larger than the other. Moreover, the number of guide shafts of the present embodiment is two but may be one. The guide shafts 121f and 121g are not required to be made of metal and may be made of a resin such as plastic.

### 2-2. Operation of Cutter Mechanism

Operation of the cutter mechanism 120 of the second embodiment will be described. Note that description that overlaps the description of the cutter mechanism 20 of the first embodiment will be omitted. Further, components that overlap the components of the cutter mechanism 20 of the first embodiment will be described by using the same reference numerals.

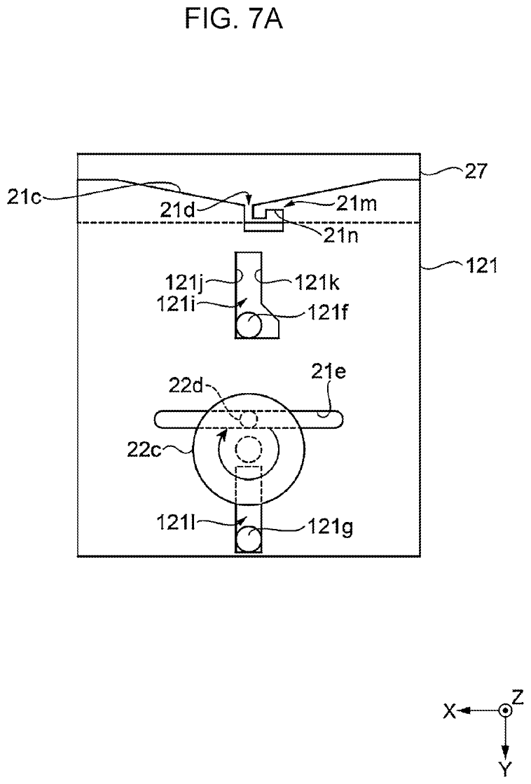

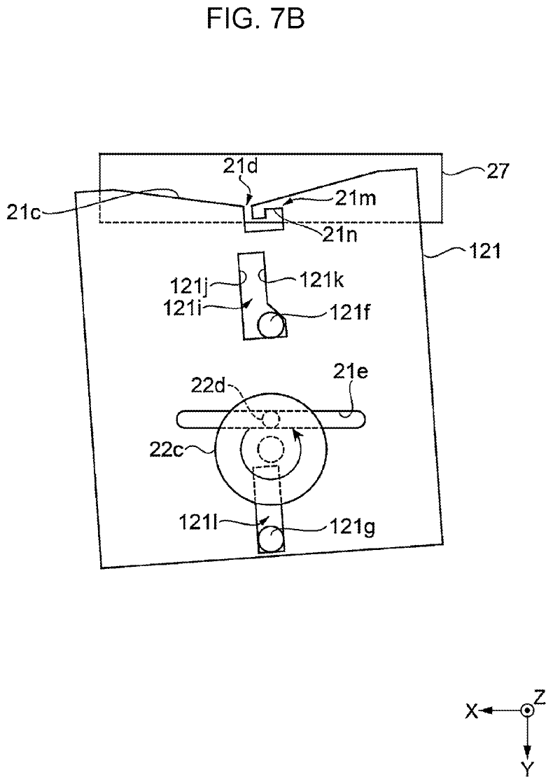

FIGS. 7A and 7B are plan views of main parts when the movable blade 121 is at the cutting position. FIG. 7A is a view for explaining the driven gear 22c rotating in the first rotational direction and FIG. 7B is a view for explaining the driven gear 22c rotating in the second rotational direction. Note that, in FIGS. 7A and 7B, regarding the plate 121h, the guide shafts 121f and 121g are illustrated and illustration of exterior shape is omitted.

In FIG. 7A, when the driven gear 22c rotates in the first rotational direction, the movable blade 121 performs the partial cutting. The crank pin 22d moves, in the first rotational direction, rearward in the Y direction and the movable blade 121 reaches the cutting position. Until reaching the cutting position, the movable blade 121 receives the force from the crank pin 22d urging movement in the X direction. In particular, while the crank pin 22d moves, along the slide groove 21e, rightward in the X direction, the movable blade 121 receives, via the slide groove 21e, the force from the crank pin 22d urging rightward movement in the X direction. In other words, at least when the crank pin 22d is moving, along the slide groove 21e, rightward in the X direction, the movable blade 121 moves toward the cutting position while being pushed by the crank pin 22d rightward in the X direction.

Since the movable blade 121 is pushed by the crank pin 22d rightward in the X direction, the first side 121j of the guide groove 121i of the movable blade 121 is in contact with the guide shaft 121f on the right side in the X direction. Then, the first side 121j moves while being in contact with the guide shaft 121f. Note that the first side 121j may be in direct contact with the guide shaft 121f or may be in indirect contact with the guide shaft 121f via another member. Since the first side 121j is a side extending in the Y direction, the movable blade 121 is guided by the guide shaft 121f via the first side 121j to move rearward in the Y direction and cuts the thermal paper S. More specifically, the V-shaped cutting edge 21c of the movable blade 121 cuts the thermal paper S and the notch section 21d of the movable blade 121 forms an uncut portion of the thermal paper S. When the driven gear 22c rotates in the first rotational direction, the movable blade 121 performs the partial cutting.

On the other hand, in FIG. 7B, when the driven gear 22c rotates in the second rotational direction, the movable blade 121 performs the full cutting. The crank pin 22d moves, in the second rotational direction, rearward in the Y direction and the movable blade 121 reaches the cutting position. Until reaching the cutting position, the movable blade 121 receives the force from the crank pin 22d urging movement in the X direction. In particular, while the crank pin 22d moves, along the slide groove 21e, leftward in the X direction, the movable blade 121 receives, via the slide groove 21e, the force from the crank pin 22d urging leftward movement in the X direction. In other words, at least when the crank pin 22d is moving, along the slide groove 21e, leftward in the X direction, the movable blade 121 moves toward the cutting position while being pushed by the crank pin 22d leftward in the X direction.

Since the movable blade 121 is pushed by the crank pin 22d leftward in the X direction, the second side 121k of the guide groove 121i of the movable blade 121 is in contact with the guide shaft 121f on the left side in the X direction. Then, the second side 121k moves while being in contact with the guide shaft 121f. Note that the second side 121k may be in direct contact with the guide shaft 121f or may be in indirect contact with the guide shaft 121f via another member. Since the second side 121k includes the first portion and the second portion, the movable blade 121 is guided by the guide shaft 121f via the first portion to move in the Y direction and then guided by the guide shaft 121f via the second portion to move in the direction inclined with respect to the cutting direction and cuts the thermal paper S.

By the movable blade 121 moving in the cutting direction, the V-shaped cutting edge 21c cuts the thermal paper S and the notch section 21d forms an uncut portion of the thermal paper S. After that, by moving in the direction inclined with respect to the cutting direction, the movable blade 121 also cuts the uncut portion of the thermal paper S. Note that the thermal paper S may be cut only by the V-shaped cutting edge 21c of the movable blade 121 without an uncut portion of the thermal paper S being formed by the notch section 21d. When the driven gear 22c rotates in the second rotational direction, the movable blade 121 performs the full cutting.

As described above, the printing apparatus 100 according to an embodiment to which the disclosure is applied is configured to perform partial cutting in which a portion of the thermal paper S remains uncut and full cutting in which the thermal paper S is completely cut, and the printing apparatus 100 includes: the movable blade 21 or 121; the plate 21h or 121h configured to support the movable blade 21 or 121; and the driven gear 22c that drives the movable blade 21 or 121, in which one of the movable blade 21 or 121 and the plate 21h or 121h includes the guide groove 21i or 121i, the other of the movable blade 21 or 121 and the plate 21h or 121h includes the guide shaft 21f or 121f configured to be coupled to the guide groove 21i or 121i, the guide groove 21i or 121i has the first side 21j or 121j and the second side 21k or 121k, the second side 21k or 121k includes a certain portion that extends in the direction away from the first side 21j or 121j, when the driven gear 22c rotates in the first rotational direction to move the movable blade 21 or 121 toward the thermal paper S, the guide shaft 21f or 121f changes the position with respect to the guide groove 21i or 121i along the first side 21j or 121j and the movable blade 21 or 121 performs the partial cutting, and when the driven gear 22c rotates in the second rotational direction different from the first rotational direction to move the movable blade 21 or 121 toward the thermal paper S, the guide shaft 21f or 121f changes the position with respect to the guide groove 21i or 121i along the second side 21k or 121k and the movable blade 21 or 121 performs the full cutting.

According to the printing apparatus 100 of the embodiment, since the guide groove 21i or 121i includes the first side 21j or 121j and the second side 21k or 121k and the second side 21k or 121k includes the certain portion that extends in the direction away from the first side 21j or 121j, it is possible to switch between the partial cutting and the full cutting by the movable blade 21 or 121 in accordance with a rotational direction of the driven gear 22c. Accordingly, an additional member for switching between the partial cutting and the full cutting is not required and it is possible to reduce cost, and it is also possible to reduce the risk of failure due to abrasion of a member.

In the printing apparatus 100 according to the embodiment, the movable blade 21 or 121 is a cutter blade of a V-shape that includes the cutting edge 21a and the cutting edge 21b as regions by which the thermal paper S is cut and the notch section 21d as a region which is provided between the cutting edges 21a and 21b and by which an uncut portion of the thermal paper S is formed.

Since the movable blade 21 or 121 has the V-shape, when the movable blade 21 or 121 moves in the cutting direction, the cutting edge 21a and the cutting edge 21b are able to cut the thermal paper S and the notch section 21d is able to form the uncut portion. Accordingly, it is possible to switch between the partial cutting and the full cutting of the movable blade 21 or 121 in accordance with a rotational direction of the driven gear 22c.

In the printing apparatus 100 according to the embodiment, when the driven gear 22c rotates in the first rotational direction, the movable blade 21 or 121 moves in the cutting direction in which the thermal paper S is cut and performs the partial cutting, and when the driven gear 22c rotates in the second rotational direction, the movable blade 21 or 121 moves in the direction inclined with respect to the cutting direction and performs the full cutting.

The movable blade 21 or 121 is able to move either in the cutting direction or in the direction inclined with respect to the cutting direction. Accordingly, it is possible to achieve the partial cutting and the full cutting of the movable blade 21 or 121 in accordance with a rotational direction of the driven gear 22c.

In the printing apparatus 100 according to the embodiment, when the driven gear 22c rotates in the second rotational direction, the guide shaft 21f or 121f changes the position with respect to the guide groove 21i or 121i along the certain portion of the second side 21k or 121k and the movable blade 21 or 121 moves in the direction inclined with respect to the cutting direction.

Since the second side 21k or 121k includes the certain portion extending in the direction away from the first side 21j or 121j, when the driven gear 22c rotates in the second rotational direction, the movable blade 21 or 121 is able to move in the direction inclined with respect to the cutting direction. Such a configuration enables the movable blade 21 or 121 to perform the full cutting.

In the printing apparatus 100 according to the embodiment, the movable blade 21 or 121 has the angled structure 21m including the cutting end 21n, and when the driven gear 22c rotates in the second rotational direction, the thermal paper S is cut by the cutting end 21n of the movable blade 21 or 121.

The uncut portion of the thermal paper S is able to be cut by hooking the uncut portion on the cutting end 21n of the movable blade 21 or 121. Accordingly, it is possible to more reliably achieve the full cutting of the movable blade 21 or 121.

In the printing apparatus 100 according to the embodiment, the cutting end 21n, which extends in the direction crossing the cutting direction, has a width larger than a width of an uncut portion of the thermal paper S.

Since the width of the cutting end 21n is larger than the width of the uncut portion of the thermal paper S, the uncut portion of the thermal paper S is easily hooked on the angled structure 21m and the uncut portion of the thermal paper S is able to be cut more reliably.

### 3. Other Embodiments

Note that the embodiments described above merely illustrate an aspect of the disclosure, and the specific aspects of the disclosure and the scope of application of the disclosure are not limited to the embodiments described above.

For example, the printing apparatus 100 illustrated in FIG. 1 has been described as a configuration in which the printing section 70 also functions as the transport section 70A that transports the thermal paper S. However, the disclosure is not limited to the configuration. For example, a configuration may be such that a transport roller or the like for transporting the thermal paper S is provided as the transport section 70A.

Further, for example, a medium cut by the cutter mechanism 20 or 120 to which the disclosure is applied is not limited to the thermal paper S having a roll shape, and may be plain paper wound into a roll or other kinds of sheets. Furthermore, the cutter mechanism 20 or 120 to which the disclosure is applied or the printing apparatus 100 including the cutter mechanism 20 or 120 may be configured to be incorporated into a device such as a multifunction peripheral or register.

What is claimed is:

1. A printing apparatus configured to perform partial cutting in which a portion of recording paper remains uncut and full cutting in which the recording paper is completely cut, the printing apparatus comprising:
a first blade;
a plate configured to support the first blade; and
a first rotating body that drives the first blade, wherein
one of the first blade and the plate includes a guide groove,
another of the first blade and the plate includes a guide shaft configured to be coupled to the guide groove,
the guide groove has a first side and a second side,
the second side includes a certain portion that extends in a direction away from the first side,
when the first rotating body rotates in a first rotational direction to move the first blade toward the recording paper, the guide shaft changes a position with respect to the guide groove along the first side and the first blade performs the partial cutting, and
when the first rotating body rotates in a second rotational direction different from the first rotational direction to move the first blade toward the recording paper, the guide shaft changes the position with respect to the guide groove along the second side and the first blade performs the full cutting.

2. The printing apparatus according to claim 1, wherein
the first blade is a cutter blade of a V-shape that includes blade sections as regions by which the recording paper is cut and a notch section as a region which is provided between the blade sections and by which an uncut portion of the recording paper is formed.

3. The printing apparatus according to claim 1, wherein
when the first rotating body rotates in the first rotational direction, the first blade moves in a cutting direction in which the recording paper is cut and performs the partial cutting, and
when the first rotating body rotates in the second rotational direction, the first blade moves in a direction inclined with respect to the cutting direction and performs the full cutting.

4. The printing apparatus according to claim 3, wherein
when the first rotating body rotates in the second rotational direction, the guide shaft changes the position with respect to the guide groove along the certain portion of the second side and the first blade moves in the direction inclined with respect to the cutting direction.

5. The printing apparatus according to claim 3, wherein
the first blade has an angled structure including a cutting end, and
when the first rotating body rotates in the second rotational direction, the recording paper is cut by the cutting end of the first blade.

6. The printing apparatus according to claim 5, wherein
the cutting end, which extends in a direction crossing the cutting direction, has a width larger than a width of an uncut portion of the recording paper.
